(19) United States
(12) Patent Application Publication
(10) Pub. No.: US 2003/0195442 A1
(43) Pub. Date: Oct. 16, 2003

(54) Automated multiaxis guidance device for automating therapeutic modalities

(76) Inventors: Terrance Paul Dyck, Nanoose Bay (CA); Alan Douglas Robb, Fanny Bay (CA); Chris John Copeman, Cumberland (CA)

Correspondence Address: Terrance Paul Dyck, 6439A Portsmouth Rd., Nanaimo, BC, V9V-1A3, CA

(21) Appl. No.: 10/391,851

(22) Filed: Mar. 20, 2003

Related U.S. Application Data
(60) Provisional application No. 60/365,787, filed on Mar. 21, 2002.

(51) Int. Cl. A61H 1/00

(52) U.S. Cl. 601/84; 601/117

(57) ABSTRACT

A multiaxis guidance device which is automated and programmable safely taking the place of a doctor or therapist in operating a variety of normally handheld therapeutic modalities. The device includes a base comprising either a portable base or a wall mounted swing arm. A vertical mast which automatically raises when shut off for more compact storage or to accomodate an operator exiting the device and automatically lowers for appropriate modality operating height when turned on. A horizontal boom mounted to the mast providing reciprocal longitudinal axial travel of the modalities. An arm mounted perpendicular to the boom comprising a unique double four bar mechanism and receptacle for attaching a variety of modalities which automatically compensates for varying body contours by raising and lowering vertically while simultaneously tipping and rotating around the transverse axis. An onboard computer comprising various sensors and a handheld controller which determine starting mast height for best modality to body contact and can be preprogrammed or reprogrammed at any time for speed of modality travel and a multitude of longitudinal travel parameters.

### CROSS REFERENCE TO RELATED APPLICATIONS

This application is based on provisional application serial number 60-365,787, filed on Feb. 26, 2002.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

1. Field of the Invention

The present invention relates to a device which takes the place of a doctor or therapist in operating various normally handheld therapeutic modalities, more specifically a device which is computer automated and programmable.

2. Discussion of Prior Art

Numerous therapeutic devices have been developed over the years to treat a variety of conditions. The most common of these devices are usually handheld manually operated devices controlled by a doctor or therapist.

Some handheld devices such as massagers are controlled by the user themselves, can be applied to any area of the body, but are difficult to use and tedious. Effective massaging with handheld devices requires repetitious manual movement of the applicator for extended periods of time which counteracts much of the relaxation effects. Furthermore, certain areas of the body cannot easily be reached by a person applying the applicator for self-massage. To obtain effective relaxing massage to cover all areas of the body, a second individual is required. Examples of manually assisted devices are described in Laroche et al, U.S. Pat. No. 5,167,22; and Isabelle et al U.S. Pat. No. 5,203,322.

Various devices disclosed in the prior art reveal numerous attempts to remove the need for a second person in providing therapy to a body or a part of a body. Several difficulties and disadvantages are apparent in the prior art. A doctor or therapist can pick and choose from a variety of therapeutic modalities for a variety of treatments or injuries. Such devices described by Raffel et al Pat. No. WO9715264; Kawakami, Pat No. EP064132; Laroche et al, U.S. Pat. No. 5, 167, 226; Cutone, U.S. Pat. No. 4,875,470; Hengl, U.S. Pat. No. 4,721,100; Wintoniw, U.S. Pat. No. 4,041,938; Isabelle et al, U.S. Pat. No. 5,203,322; Cutter et al, I.P.N. WO 98/05288; and Persaud, U.S. Pat. No. 4,984,568 are limited in their choice or diversity of therapy lacking in adaptability to a large variety of support surfaces, conditions or body regions to be treated.

A doctor or therapist can easily transport a variety of modalities for use in different rooms however, a lack or portability is seen in such devices as described in Cutone, U.S. Pat. No. 4,875,470; Hengl U.S. Pat. No. 4,721,100; Skovira, U.S. Pat. No. 5,456,656; Lipowitz, U.S. Pat. No. 5,083, 552; and Wintoniw, U.S. Pat. No. 4,041,938. Many of these devices take up a significant amount of room and can't be easily stored making them both less practical and less cost effective especially in a clinical or business setting where it would be very difficult to use the room or patient table for other forms of treatment.

In the case of some semi-portable units such as described in Persaud, U.S. Pat. No. 4,984,568; Isabelle et al U.S. Pat. No. 5,203,322; and Laroche et al, U.S. Pat. No. 5,167,226; which require being clamped to a bed or connected to a support arm which is either clamped to a bed or wall, it would make access to using both sides of a bed limited which also then limits the scope of uses for the bed. Many professionals such as chiropractors, physiotherapists and massage therapists need to work from both sides of the bed so constantly moving and replacing such devices would be impractical. Many beds, therapy tables or other body support surfaces are constructed in numerous fashions and these devices would lack compatibility to most support surfaces.

With automated therapeutic devices difficulties arise in following body contours. Lipowitz, U.S. Pat. No. 5,083,552; describes a complicated computer and sensor system requiring constant feedback to prevent binding or jamming of the applicator on a person. This is made more difficult because the applicator can't tip, which does not allow more of its surface area to conform with the body surface. Programming the vertical component is difficult as this parameter can change constantly simply with breathing.

Skovira, U.S. Pat. No. 5,456,656; Cutone, U.S. Pat. No. 4,875, 470; and Wintoniw U.S. Pat. No. 4,041,938; describe massaging devices where the bulk of the working mechanism and the massaging apparatus are positioned directly above the user's body. This places more weight above the user and requires the base or supporting system to be much heavier and less portable. It also poses a greater risk of injury to the user if sensors and lift of the mechanism were to fail.

Persaud, U.S. Pat. No. 4,984,568 describes a device with a pivotally mounted transverse arm or activating rod which provides reciprocal parallel linear movement for a massaging implement pivotally secured on the distal end of the actuating rod. As the massaging implement is moved longitudinally the arm moves about the pivot in a circumferential fashion requiring constant change in the acutating rod length to compensate for alignment of the implement over the body. Unfortunately, because of the circumferential movement of the massaging implement it will not remain parallel with the alignment of a body except at the very midline of it's arc. The massaging implement itself would have to rotate to compensate for this circumferential motion. A remote control joystick is available for the user however, this would require constant operation and would not seem overly relaxing. The implement only pivots as it moves transversely across the body and not longitudinally which can cause jamming or binding on the body due to contour changes which can lead to greater chance of injury.

Skovira, U.S. Pat. No. 5,456,656; discloses a device which uses an off the shelf shiatsu type modality and that other modalities could be interchanged. For a device to be more effective and valuable this modality exchange needs to be quick and simple.

Some of these aforementioned automated devices have a pivoting mechanism for the therapy implement however, they are located well above the contact surface again leading to greater binding forces and greater risk of injury. Safety is a concern whereby the user should be able to easily exit from treatment in case of panic, pain, or other emergency even if the device is operating and without greater risk of injury.

### OBJECTS AND ADVANTAGES OF THE INVENTION

Accordingly several objects and advantages of the invention are:

a) to provide a machine that can safely take the place of a doctor or therapist in operating a variety of normally hand-held therapeutic modalities

b) to provide a machine where various modalities can be interchanged quickly and easily.

c) to provide a machine having an onboard programmable computer with hand-held controller capable of setting a multitude of parameters to suit a variety of modalities, which can be operated by the user with one hand while totally relaxed in any of a variety of positions for treatment such as prone, supine, side posture or sitting.

d) to provide a machine which has a built in program which can be altered at any time by the doctor, therapist or user to suit the type of modality used, the type of therapy needed, the area to be treated or user preference.

e) to provide a machine that is not tedious to operate but is rather safe, quick and easy to learn to operate for most people from children to seniors.

f) to provide a machine that uses a simple but effective mechanical system to conform to the various body contours, overcome obstacles such as clothing or belts etc. as the user may be clothed and prevent binding with skin of an unclothed user, without the need for an elaborate sensor and feed back system.

g) to provide a machine that is very safe whereby user programming mistakes or machine failure does not result in injury and the user can exit or shutdown the machine safely and easily anytime in case of panic or emergency even while the machine is operational.

h) to provide a machine that has a simple but safe method for increasing or decreasing modality pressure on a body, without the need of hydraulics, motors and complicated pressure sensors while maintaining the easy escape feature even if the device is operating.

i) to provide a machine with a power supply that will shut down if overloaded and drive motors that have a built in stall for safety.

j) to provide a machine with a convertible power supply of either 110V-60 Hz or 220V-50 Hz which supplies a 12V power transformer to supply the controllers and drive motors for a safer system.

k) to provide a machine with a programmable controller capable of pulse width motor control allowing cooler running of the power transistor, and reversing motor direction.

l) to provide a machine with a variety of support bases including a height adjustable wall mounted swing arm system and a portable compact yet very stable base which resists tipping in any normal use and where these bases allow the device to be used in conjunction with almost any bed, bench, professional therapy table, couches, chairs etc.

m) to provide a machine that is built in compact ergonomically designed components for ease of manufacture, service, installation, changing support bases, transport, set up or storage which also allows a doctor or therapist to use existing treatment rooms for multiple purposes.

n) to provide a machine that self adjusts to a combination of size, shape, and support surface height.

o) to provide a machine which reduces the transference of unwanted forces from modalities with there own built in action such as vibration, percussion, etc back to the machine.

p) to provide a machine with high user satisfaction, comfort and therapeutic value making it both clinically and economically valuable.

Further objects and advantages of the present invention will become apparent from the following descriptions, taken in connection with the accompanying drawings, wherein, by way of illustration and example, an embodiment of the present invention is disclosed.

### SUMMARY OF THE INVENTION

Briefly stated the invention is an automated multiaxis guidance device which safely takes the place of a doctor or therapist in the operation of a variety of normally handheld therapeutic modalities. The system includes an onboard programmable computer with handheld controller, interchangeable support bases providing superior versatility and portability, an automated vertically adjustable mast to compensate for varying body and support surface heights, a boom providing automated reciprocal longitudinal travel, an arm combining a double four bar mechanism with a modality receptacle providing superior adaptability of a variety of therapeutic modalities to varying body contours, while preventing binding or jamming on a body, clothes, or belts etc.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

The foregoing summary, as well as the following detailed description of the presently preferred embodiments of the invention will be better understood when read in conjunction with the appended drawings. For the purpose of illustrating the invention, there is shown in the drawings, an embodiment which is presently preferred. It should be understood, however, that the present invention is not limited to the particular arrangement and instrumentality shown in the drawings:

FIG. 1 is a side view of an automated multiaxis guidance device for automating therapeutic modalities;

FIG. 2 is a front view of the automated multiaxis guidance device shown in FIG. 1, with the boom motor cover removed;

FIG. 3 is a top plan view of the device shown in FIG. 1;

FIG. 4 is a rearview look at the boom motor and electronics with the boom motor cover removed;

FIG. 5A is a cross-sectioned view of the boom and arm carrier taken along lines 5a-5a of FIG. 3;

FIG. 5B is a longitudinal crossectional view of the boom and arm carrier taken along lines 5b-5b of FIG. 3;

FIG. 6A is a frontal view of an alternative embodiment of the optional adjustable wall mounted swing-arm support system.

FIG. 6B is a top plan view of an alternative embodiment of the optional swing arm support system shown in FIG. 6A;

FIG. 7 is a perspective view of the handheld control mouse.

FIG. 8 is an overall block diagram of the various components making up the computer and electronics portion of the system;

FIGS. 9A-9E is a flow diagram illustrating the operation of the system of FIG. 8

FIG. 10 schematically illustrates the programmable controller circuit board and electronics of the system of FIG. 8

### DETAILED DESCRIPTION OF THE PREFERRED EMBODIMENT

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

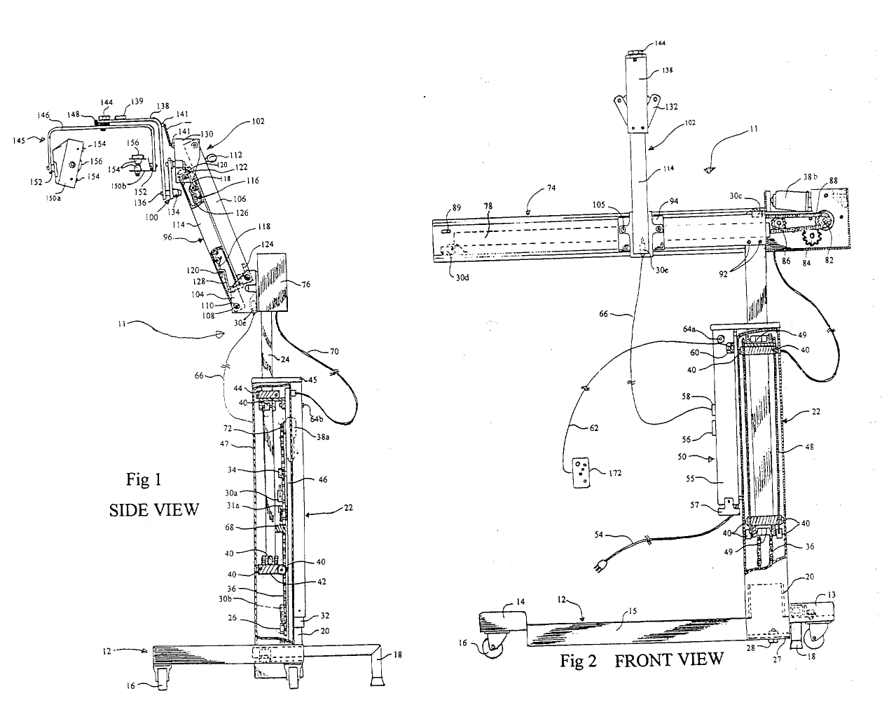

Referring now to the drawings in detail, wherein like numerals indicate like elements throughout, there is shown in FIG. 1, a preferred embodiment of a device, generally designated 11, for automating various normally hand held modalities (not shown) in accordance with the present invention.

Referring now to FIGS. 1-3 in the present embodiment it is preferred that the automated multiaxis guidance device 11 has a portable base assembly 12 comprising a mast foot 13 and distal foot 14 joined at their posterior aspects by a cross beam 15 fastened by welds. Lockable casters 16 are affixed with bolts to the undersurface of mast foot 13 and distal foot 14. It is understood by those skilled in the art that the particular joining of parts may be done by various means without departing from the spirit and scope of the invention. The mast foot 13 has a retractable stablizing leg 18 which slides in and out of the posterior aspect of mast foot 13. The stabilizing leg 18 extends posteriorly for safety to prevent backward tipping of device 11 and retracts into mast foot 13 for easier transport or more compact storage of device 11. Mast foot 13 and distal foot 14 are spaced well apart and are positioned forward relative to the more forward operating center of gravity of device 11. The unique design is similar to that of a human stance preparing a stable balanced posture for lifting, working and for using a modality on another person. This unique design of portable base assembly 12 allows device 11 to be positioned properly for a multiple of modality therapies on a patient who may be prone, supine, side posture or sitting on a variety of body support surfaces (not shown) such as professional therapy tables, benches, couches, beds, chairs etc.

Now referring to FIGS. 1 and 2 mast support post 20 extends vertically and is welded to the top of portable base assembly 12. Mast assembly 22 sits vertically on base 12, and is affixed in position by the mast support bracket 32 which wraps around mast support post 20 with mast anchor bolt 28 passing through mast platform 27 and mast assembly 22.

Mast assembly 22 has an outer housing 47 and a lid 45 which encase the working components of mast assembly 22. Mast mounting plate 46 slides into mast assembly 22 and provides attachment for mast drive motor 38a, mast idler sprocket 34, upper limit switch 30a mast circuit interface 31a, lower limit switch 30b and mast end sprocket 26. Upper mast guide plate 44 is attached with standard nuts and bolts (not shown) to the upper end of mast mounting plate 46. Lower mast guide plate 42 is welded to the lower end of mast 24.

A series of rollers 40 and mutlirollers 49 are mounted to upper mast guide plate 44 and lower mast guide plate 42. As mast 24 moves vertically up or down it moves through the stationary upper mast guide plate 44 contacting rollers 40 and multirollers 49 for smooth fluent travel. Lower mast guide plate 42 travels vertically up and down with mast 24 while its rollers 40 and multirollers 49 contact mast mounting plate 46 and housing 47 providing fluid tracking of mast 24.

Mast drive chain 36 loops around mast drive sprocket 72, mast idler sprocket 34 and mast end sprocket 26. Mast drive sprocket 72 is powered by mast drive motor 38a. A u-chain bracket 68 is welded to the back side of mast 24 within housing 47 and facing mast drive chain 36. U-chain bracket 68 attaches mast 24 to mast drive chain 36 with a standard nut and bolt (not shown).

Referring now to FIGS. 1,2 & 8, onboard computer 50 supplied by power cord 54, is surrounded by casing 55, covered on top by lid 45, on the bottom by pan 57 and is attached to the outside of mast assembly 22 with standard screws(not shown). Onboard computer 50 comprises a programmable controller circuit board 51, DC Power supply 52, AC relay 53, handheld controller 172, encoder 81, and a series of limit switches 30a-e. Handheld controller 172 connects to onboard computer 50 via controller cable 62 which plugs into computer port 60. Arm limit switch 30e connects to onboard computer 50 via arm wiring 66 which plugs into arm wiring port 58. An emergency shutoff 64a located on onboard computer 50 is available in the event the operator forgets how to use the handheld controller or panics. An override shutoff 64b is located on the back of mast assembly 22 which can overide the operator using handheld controller 172.

Referring now to FIG. 2 &7, handheld controller 172 is connected to onboard computer 50 via controller cable 62 which plugs into controller port 200 located on the side of handheld controller 172. Handheld controller 172 comprises speed control 202, start/stop button 204, reverse limit button 206, pause button 208 and forward limit button 210 which are used to set the parameters of treatment desired by the operator of device 11 or by the doctor or therapist for parameters required for a specific modality or a specific type of therapy.

Referring now to FIG. 8 block diagram of device electronics describing the components within the 12 volt DC maximum voltage, and those components outside the 12 volt DC maximum voltage. Drive motors 38a-b, handheld controller 172, limit switches 30a-e, encoder 81 and emergency shutoff 64a all connect to programmable controller circuit board 51 within the 12 volt DC maximum voltage. DC power supply 52, AC relay 53, and the modality remain outside the 12 volt maximum voltage with the modality connecting to AC relay 53 which in turn connects to both programmable controller circuit board 51 and DC power supply 52 with DC power supply 52 also connecting to programmable controller circuit board 51.

Referring now to FIGS. 2 to 4 boom assembly 74 attaches to the top of mast 24 with boom anchor bolts 92. Boom assembly 74 is aligned horizontally and parallel to the floor and perpendicular to mast 24. Boom 78 makes up the structural core of boom assembly 74 and is covered for both safety and esthetics at one end by boom motor cover 76 and cover plate 77 while boom housing 75 covers the rest of boom 78. Boom motor cover 76 houses several components including boom drive motor 38b, which turns boom drive sprocket 82, in turn powering boom chain 88. Boom idler sprocket 86 is positioned between boom chain 88 providing proper alignment and tracking of boom chain 88. Encoder sprocket 84 is in contact with boom chain 88 and is rotated according to forward or reverse movement of boom chain 88. These rotations are counted by encoder 81 attached to encoder sprocket 84 for determining position of arm assembly 102 on boom 78 and the soft limits of travel for arm assembly 102 programmed in onboard computer 50. Boom end sprocket 90 is located at the distal end of boom 78. End sprocket adjustment screw 89 adjusts boom end sprocket 90 to set proper tension of boom chain 88. Proximal limit switch 30c and distal limit switch 30d determine the hard limits of travel for arm carrier 94 and attached arm assembly 102 as they travel along boom 78. Encoder 81, proximal limit switch 30c and distal limit switch 30d are wired to the boom circuit interface 31b attached to the back side of boom 78 within boom motor cover 76. Boom wiring port 158 is mounted on boom circuit interface 31b. Wiring bundle 70 connects boom wiring port 158 and boom drive motor 38b to onboard computer 50.

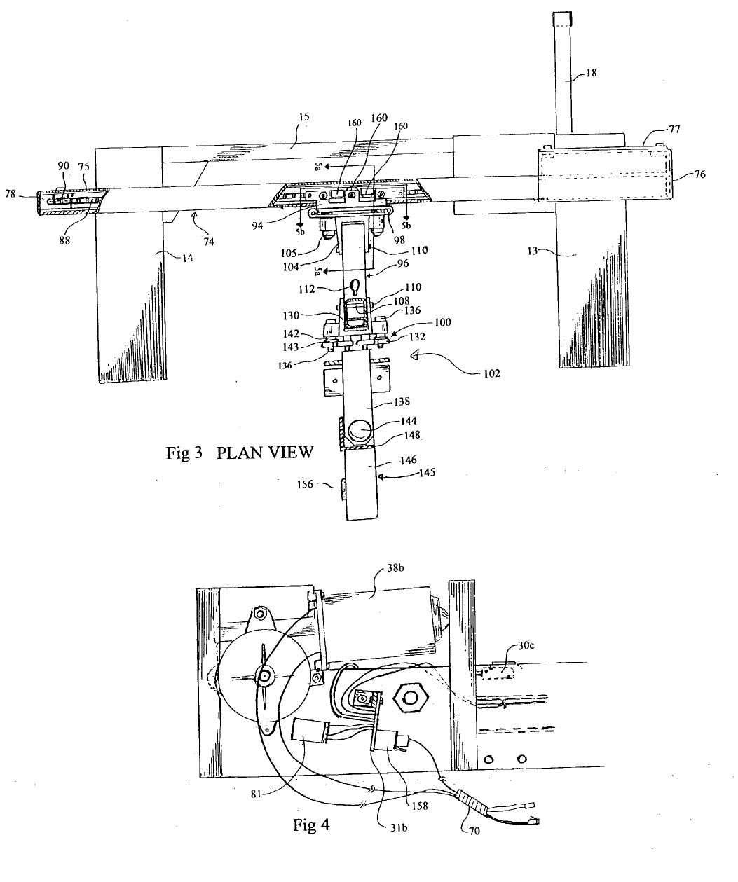

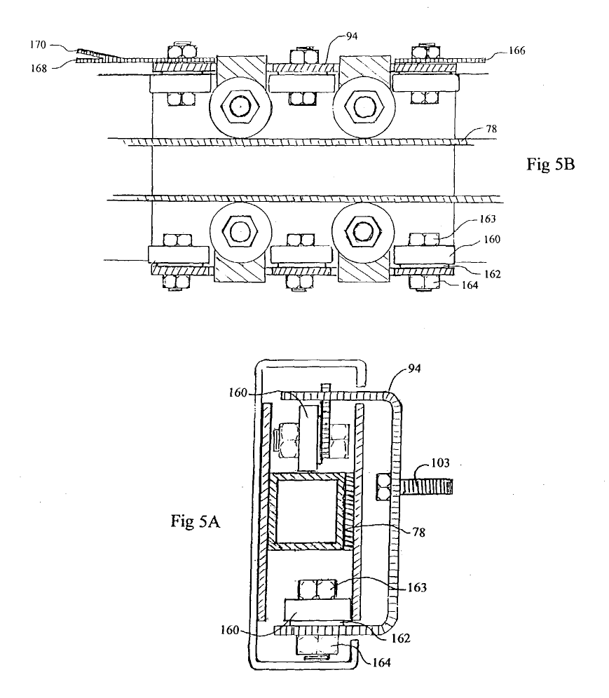

Referring now to FIGS. 3, 5A & 5B, boom chain 88 attaches to arm carrier 94 via motor side boom chain anchor 168 and outboard boom chain anchor 166 with standard nuts and bolts (not shown). A switch tripping tab 170 is located on motor side boom chain anchor 168. Arm carrier 94 rolls smoothly back and forth along boom 78 due to a series of bearings mounted to arm carrier 94 with standard bolt 163, large washer 162 and standard nut 164. Arm mounting bolts 103 are for attachment of arm assembly 102.

Referring now to FIGS. 1, 2, 3, arm assembly 102 is mounted to arm carrier 94 with arm mounting bolts 103 passing through arm carrier 94 and lower arm bracket 104 of arm assembly 102 and affixed with arm mounting nuts 105. If optional locking arm hinge 98 is used then shorter bolts and nuts (not shown) are used to affix arm hinge 98 to arm carrier 94. Arm mounting bolts 103 can then attach arm assembly 102 to arm hinge 98.

Arm assembly 102 includes a double four bar mechanism comprised of four bar mechanism A 96 mounted perpendicular to and attached to arm carrier 94 of boom assembly 74 and four bar mechanism B 100, mounted to upper arm bracket 130 of four bar mechanism A 96 at its superior end of links 132 with bearing shoulder bolts 136 which pass through long bearing bushing 142 within upper arm bracket 130 and though small washer 143 before threading into links 132. Arm assembly 102 also includes modality receptacle 138 attached at its inferior end to the inferior end of links 132 with bearing shoulder bolts 136 passing through bearing dowels 134 within links 132 and threading into the inferior end of modality receptacle 138. Receptacle spring 140 connects between modality receptacle 138 at its top corner and the upper end of upper arm bracket 130 with receptacle spring anchors 141. Receptable spring 140 is expanded building rebound tension as modality receptacle 138 and respective modality tips either direction around its axis following body contours with the resulting tension aiding this smooth contouring action and reducing binding forces. Receptacle weights 139 may be attached to or removed from modality receptacle 138 as one method of easily varying modality pressure without altering the safety of the double four bar mechanism of arm assembly 102. It would be understood by those skilled in the art that this is an example of one method that has many variations without departing from the spirit and scope of the invention. For example the weighting could also be attached to or built into the modality adaptor or a sliding weight system built into upper arm tube 106 of four bar mechanism A 96. Four bar mechanism A 96 has upper arm tube 106 and lower arm tube 114 connecting lower arm bracket 104 and upper arm bracket 130. Arm pins 108 slide through upper arm tube 106, lower arm tube 114 and short bushings 110 found within each side of lower arm bracket 104 and upper arm bracket 130 providing proper movement of four bar mechanism A 96.

Arm locking pin 112 locks arm assembly 102 in its upper most position when not in use for more compact storage or easier transportation. Arm locking pin 112 comprises a spring loaded mechanism (not shown) within upper arm tube 106 however this mechanism is well understood by those skilled in the art and represents only one of many methods that may be used for this purpose without departing from the spirit and scope of the invention.

Arm assembly 102 includes an adjustable modality counterweighting spring mechanism 116 located within lower arm tube 114. The components comprising the adjustable modality counterweight spring mechanism 116 include expansion spring 116 connected at each end to eye bolts 118, with the distal eyebolt 118 passing through L-bracket anchor 122 and locked in place with adjusting nut 120. L-bracket anchor 122 wraps around arm pain 108 to anchor it's position in place. Proximal eyebolt 118 passes through spring link 128 and locks in position with adjusting nut 120. Springlink 128 is attached to arm rest 124 with a standard nut and bolt (not shown). Arm rest 124 exits a recess cut out of the top proximal end of lower arm tube 114, enters the proximal end of upper arm tube 106 wrapping around arm pin 108 to lock in place.

Modality counterweighting spring mechanism 116 is adjustable for tension by tightening adjusting nuts 120 on eye bolts 118 to compensate for varying weights of modalities or pressure desired. A slight positive lift on arm assemble 102 and the respective modality by modality counterweighting spring mechanism 116 is often desirable to assist the smooth body contouring action of device 11.

Referring now to FIGS. 1 & 2 modality adaptor 145 connects to modality receptacle 138 with receptacle lock 144 yet allows rotation of modality adaptor 145, 90 degrees which is important as some modalities provide a different pattern of therapy by simply rotating them. Rotational stop 148 is attached to mounting bracket 146 of modality adaptor 145 providing a stopping point at either end of the 90 degree rotation pattern. The receptacle lock 144 is demonstrating one method of quick attachment for various modality adaptors 145 however, it would be understood by those skilled in the art that several means of quick attachment of the various modality adaptors (not shown) could be configured to provide the same end result without departing from the spirit and scope of the invention.

Modality adaptor 145 has a mounting bracket 146 to which are attached handle brackets 150a and 150b with small bolts(not shown) and rubber bushings 152 positioned between mounting bracket 146 and handle brackets 150a and 150b. Rubber handle bushing 154 are positioned within handle brackets 150a and 150b to conform and grip the handle and finger space of a specific modality when tightened down by handle locks 156. Rubber bushing 152 and rubber handle bushing 154 of modality adaptor 145 minimize the transference of unwanted vibrational forces from self powered modalities to the user or to the device 11.

It should be noted that the modality adaptor 145 described herein is specific to a modality commonly used in the health care field, however it would be understood by those skilled in the art that although the basic features described herein may be used in adaptors for many other modalities, the size, shape, weight, positioning and/or materials used in construction of the different modality adaptors may vary due to the varying features of each modality and the type of treatment produced without departing from the spirit and scope of the invention.

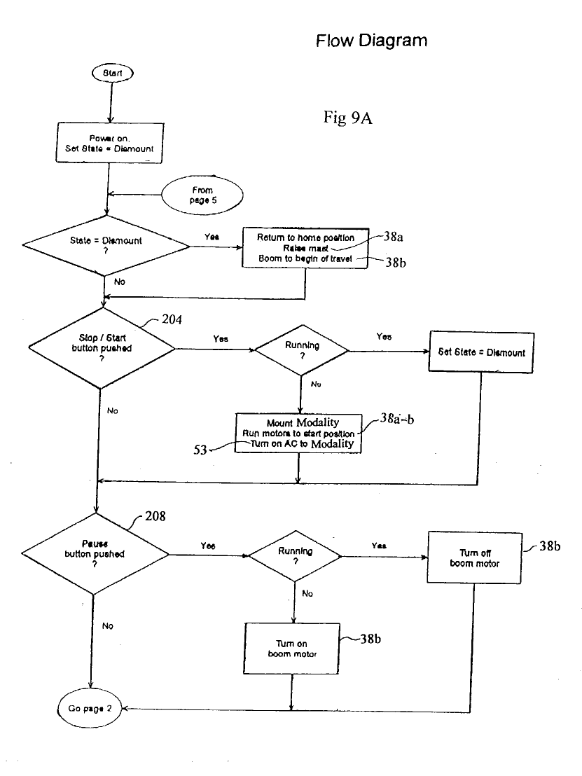

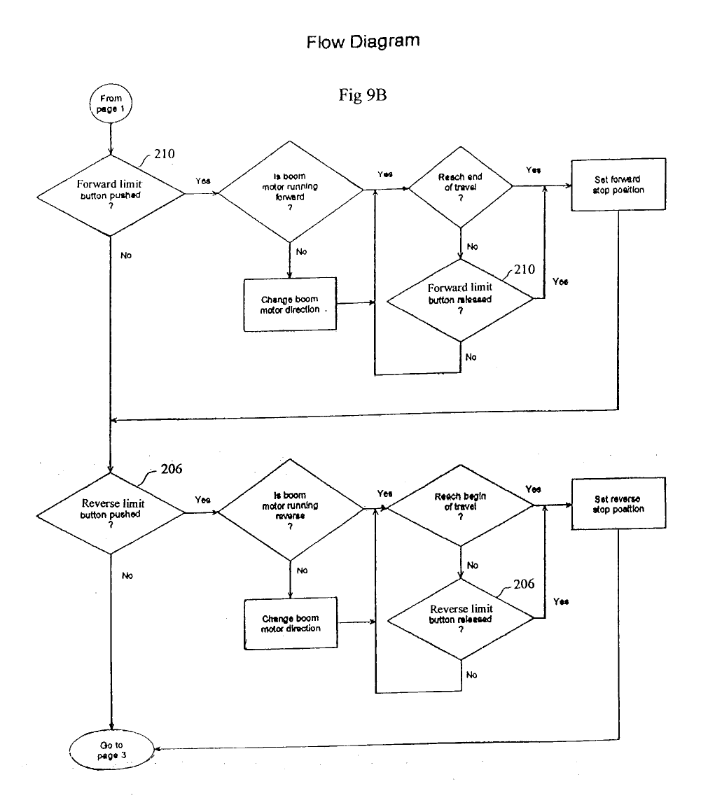

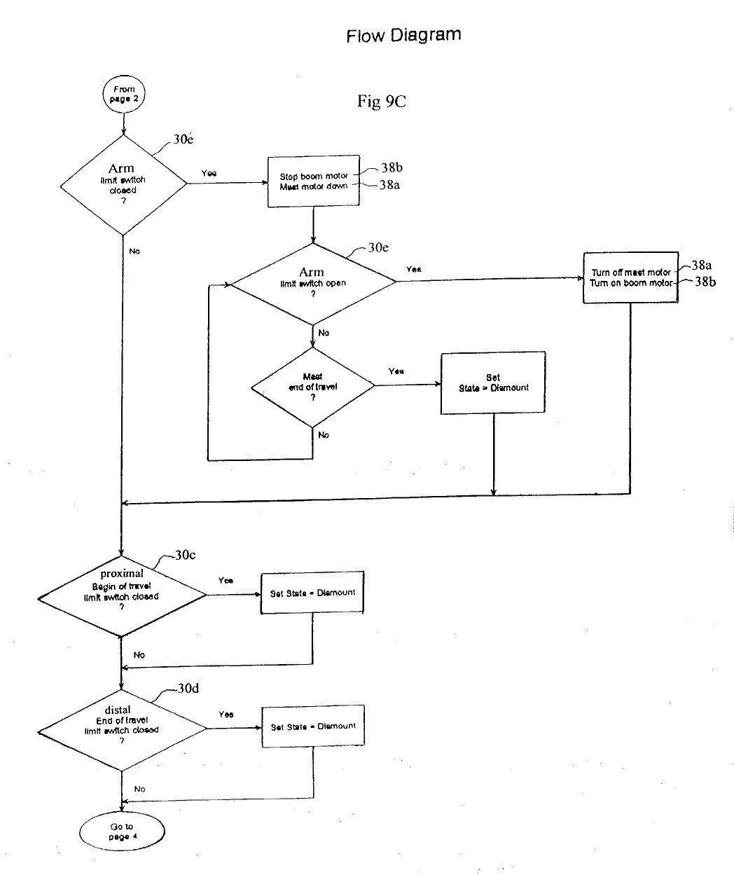

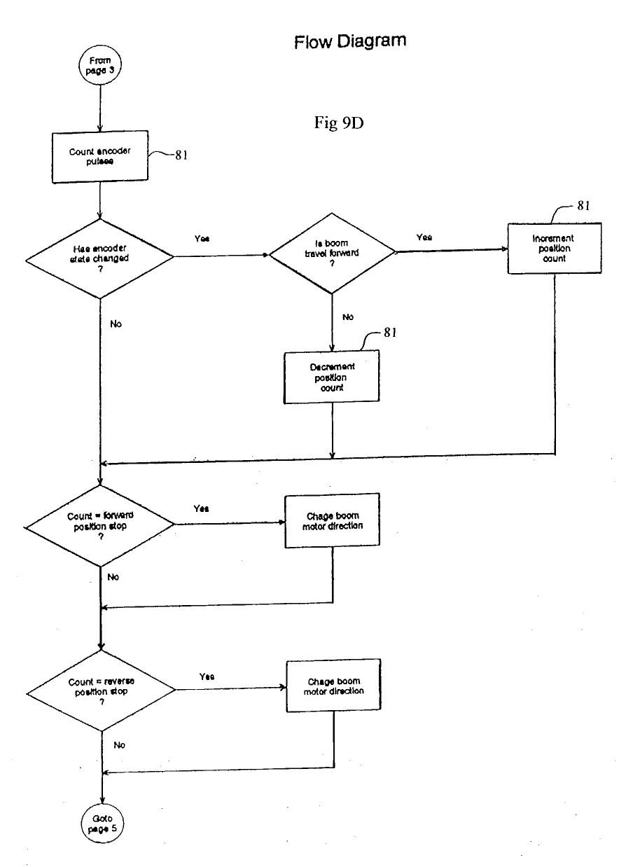

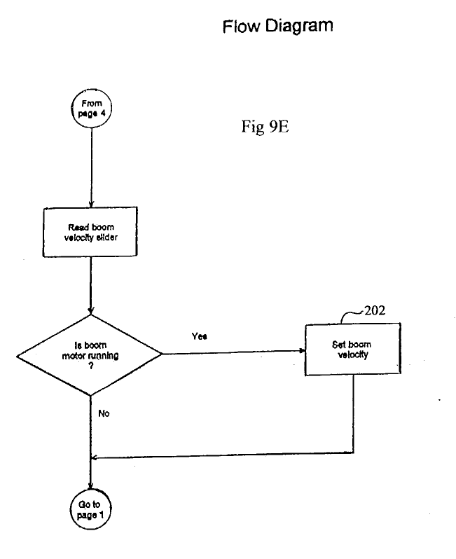

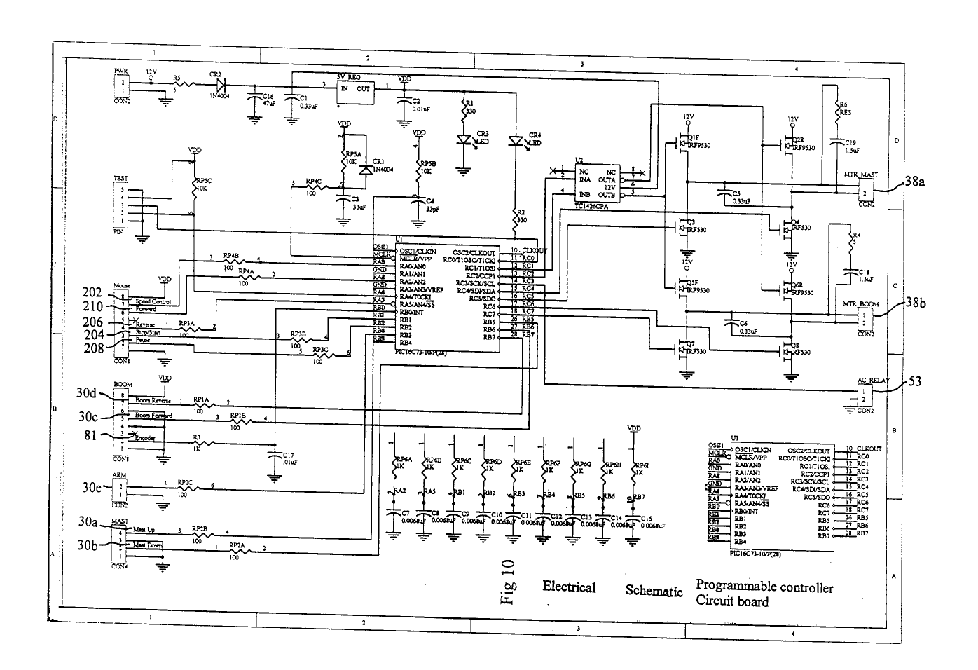

Referring now to FIGS. 9A-9E representing a flow diagram which illustrates the operation of the electrical components of device 11 as represented in FIG. 8. The resultant function is displayed following initiation of start/stop button 204, speed control 202, pause button 208, forward limit button 210, reverse limit button 206, the triggering of arm limit switch 30e and encoder 81.

Referring now to FIG. 10, showing a detailed electrical schematic of programmable controller circuit board 51 and its connection to AC relay 53, mast drive motor 38a, boom drive motor 38b, limit switches 30a-e, encoder 81, handheld controller 172 and its respective speed control 202, start/stop button 204, reverse limit button 206, pause button 208 and forward limit button 210.

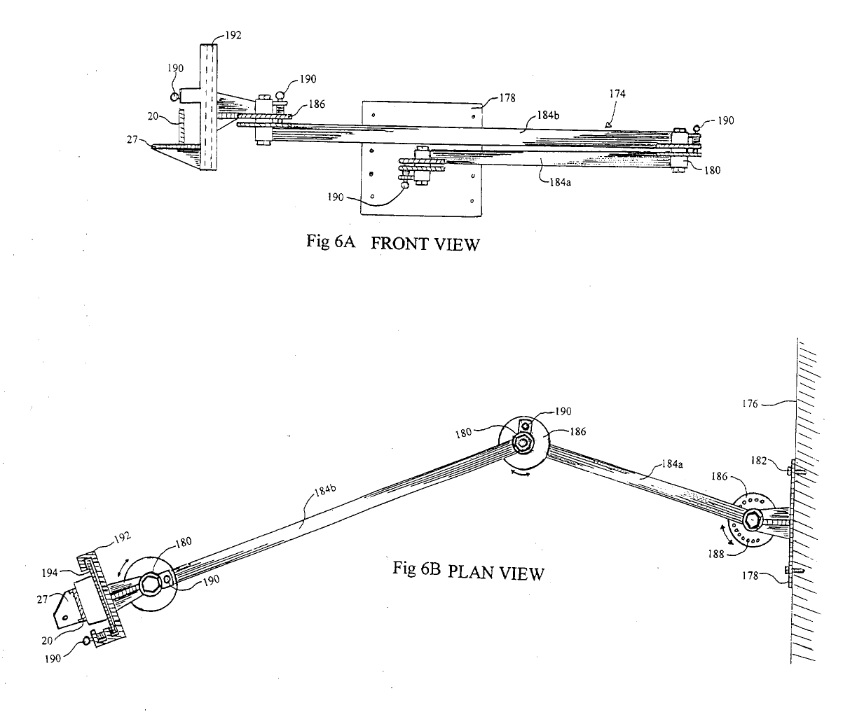

FIG. 6A & 6B—Additional Embodiments.

Additional embodiments are shown in FIG. 6A & 6B showing an alternative mounting system for device 11 other than portable base assembly 12. Swing arm system 174 is an optional adjustable wall mounted support system which mounts to wall 176 with mounting screws or bolts 182 passing through mounting plate 178 and anchoring to the structural supports of wall 176. Lower swing arm 184a and upper swing arm 184b are joined in the middle by large bearing 180 and its attached positioning discs 186. A second large bearing 180 and positioning discs 186 join the proximal end of lower swimg arm 184a and mounting plate 178. A third large bearing 180 and positioning discs join the distal end of upper swimg arm 184b with vertical track 192. Each large bearing 180 has two positioning discs 186, one with a number of positioning holes 188 while the opposing disc has a single hole through which passes positioning pin 190 which is attached to one side of large bearing 180 and one of the opposing positioning discs 186. Mast platform 27 and attached mast support 20 are affixed to vertical rail 194 which can slide up or down in a vertical fashion within vertical track 192 then locked into the desired height position by positioning pin 190.

It should be noted that various design changes could be used in the afformentioned swing arm system 174 without departing from the spirit and scope of the invention. For example, positioning pins 190 show a spring loaded pin mechanism however any number of position locking systems such as electromagnetic locks could be used. The wall mounted swing arm system 174 could also be designed with the arms and bearings rotated 90 degrees so the bending action is in the vertical plane as long as the mast attachments are rotated to keep the mast vertical. An additional design for a wall mounting system is a dual four bar parallel mechanism in which two separate four bar mechanisms are joined end to end with the proximal end of the first four bar mechanism attached to a wall mounting plate while the distal end of the second four bar mechanism attaches to the mast mounting components whereby such a design always keeps mast platform 27 level and mast 24 vertical.

Mast assembly 22 of device 11 can be quickly switched back and forth between mast platform 27 of portable base assembly 12 and mast platform 27 of swing arm system 174.

Advantages—From the description above a number of advantages of the automated multiaxis guidance device become evident:

a) The device is extremely portable and can easily be moved from room to room, or from storage position to operating position and back.

b) The device is versatile in that it can accommodate a variety of modalities, compensate for varying body types and sizes, provide a wide array of therapies, treat numerous areas on a body and treat a person in various postures such as prone supine, side posture or sitting while on a variety of support surfaces.

c) The device is compact and can be moved and stored out of the way while a therapy room is used for other therapies or treatments.

d) The device can take the place of a doctor or therapist in operating a variety of normally handheld modalities.

e) A doctor or therapist can attend to more patients as some patients may be getting a pre or post therapy using the device.

f) A variety of modalities can be interchanged quickly and easily.

g) The user can be clothed for many of the massaging type therapies as the unique body contouring action reduces binding forces and prevents snagging or catching on clothing without the need of an elaboratge sensor and feedback system.

h) The unique design and programming allows the user to control and or change the program parameters with a minimum amount of time or effort allowing for greater relaxation and therapeutic benefit.

i) The device is extremely safe where system failure or programming mistakes cannot lead to added forces placed upon the user and the user can exit from the device safely even during operation if an emergency or panic situation were to arise.

j) The variety of device mounting support surfaces such as the portable base and the wall mounted swing arm system add a unique advantage to the device as the interchangability is quick and easy with one support being more portable while the other support can adapt the device to tables and benches of greater height although the portable system can adjust to most combinations of standard tables or benches and varying body sizes.

k) The device has a built in convertable power supply between 110v-60 Hz or 220v-50 Hz making it readily saleable in many countries.

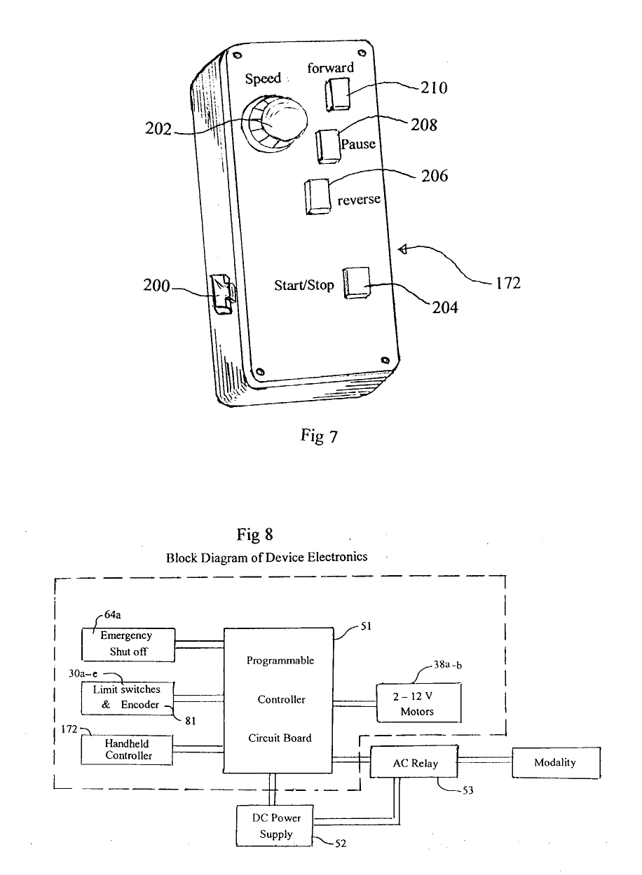

Operation FIGS. 1, 2, 3, 7, 9A-E

The operation of the automated multiaxis guidance device begins with choosing the desired modality and fitting it to the appropriate modality adaptor 145. In the example described the modality handles are placed between the rubber handle bushings 154 and tightened with handle locks 156. Modality adaptor 145 is then attached to modality receptacle 138 with receptacle lock 144. The modality can be rotated 90 degrees which is desirable for some modalities and therapies. This is done by slightly loosening receptacle lock 144 and rotating modality adaptor 145 until it contacts the rotation stop 148, then simply retighten receptacle lock 144.

Device 11 is rolled into position for use on lockable casters 16 with boom 78 usually aligned parallel to the users body or part of the body being treated. For accurate positioning arm assembly 102 is lowered by pulling up on arm locking pin 112 and the modality is positioned over the area to be treated before locking in casters 16. Before turning on device 11 retractable stabilizing leg 18 is extended for added safety.

Before device 11 will operate, the power switch of the attached modality must be in the on position with the modality plugged into modality power outlet 56, power cord 54 must be plugged in and both emergency shut off 64a and override shut off 64b must be in the on position. If device 11 was stopped for any reason during its operation by either unplugging it, using emergency shut off 64a or override shut off 64b, device 11 stops in its position immediately and when restarted will first return to its home position ready for operation. Now either a doctor, therapist or the operator of device 11 may start therapy by pushing start/stop button 204 of handheld controller 172 toggling device 11 to the on mode. With arm assembly 102 unlocked it sits just below a horizontal position and rests on arm limit switch 30e. When start/stop button 204 is depressed, arm carrier 94 moves along boom 78 to the starting position for the preprogrammed pattern where it stops and waits as mast drive motor 38a engages to lower mast 24 until the modality contacts a body or part of a body to be treated raising arm assembly 102 to approximate horizontal and lifting it off arm limit switch 30e. At this time mast drive motor 38a stops and boom drive motor 38b is engaged moving arm carrier 94 back and forth along boom 78 in the preprogrammed pattern while at the same time power to the modality is initiated through AC relay 53 turning on the modality.

The modality will continue on this preprogrammed pattern unless parameters are changed using handheld controller 172. To change the forward limit of travel hold down forward limit button 210 until the desired end point of travel is reached and release forward limit button 210. If arm carrier 94 is moving away from the present reverse limit setting at the time of setting the forward limit then arm carrier 94 will reverse its direction of travel back toward the reverse limit when forward limit button 210 is pressed and released setting a new forward limit parameter. If arm carrier 94 is moving toward the present reverse limit setting at the time of pressing and releasing forward limit button 210, arm carrier 94 will stop reverse slightly, briefly testing this new forward limit parameter, before reversing again to move in its original direction toward the reverse limit setting.

To set the reverse limit of travel the procedures are the same as for setting the forward limits described above except the pattern is reversed in direction with reverse limit button 206 being used.

Pause button 208, is used stop the modality in a specific area for a more localized or concentrated treatment if desired. Simply press and release the pause button 208 to stop the travel of arm carrier 94. To resume travel of arm carrier 94 simply press and release pause button 208 once again and arm carrier 94 will resume moving within the parameters that were last programmed prior to pausing. Speed of travel of arm carrier 94 and the respective modality can be increased or decreased as desired with speed control 202.

During operation, four bar mechanism A 96 of arm assembly 102 compensates for varying heights of the body or part of a body being treated as the modality travels along its course. In some cases where there is a large variation such as a person with a large chest size and small waist size the modality may drop down enough causing four bar mechanism A 96 to again contact arm limit switch 30e engaging mast drive motor 38a further lowering mast 24 until four bar mechanism A 96 is off arm limit switch 30e stopping mast drive motor 38a. This resets mast 24 height to provide a good average range of up and down travel of four bar mechanism A 96 as determined by body shape and size which also helps provide maximum modality to body surface area contact.

As a modality moves along a body or part of a body the up and down action of four bar mechanism A 96 maintains modality level while raising and lowering the modality according to height of the body surface. As the modality travels along a body or part of a body four bar mechanism B 100 provide a tilting and tipping action of the modality compensating for various curves or slopes of a body or part of a body thereby maintaining maximum modality to surface area contact and reduced binding forces of a modality on skin or clothing. Four bar mechanism B 100 achieves this operation by moving the effective pivot point of the modality to below the contact surface with the body.

In order to stop the operation of device 11 simple press and release start/stop button 204 which will shut off power to the modality, engage mast drive motor 38a to raise mast 24 to maximum height lifting arm assembly 102 and respective modality off the operator and then engage boom drive motor 38b to return arm carrier 94 to the home position. If either emergency shut off 64a or override shutoff 64b are engaged during operation device 11 will immediately stop in its present position overiding handheld controller 172. If during operation the operator exits therapy without stopping device 11 or if device 11 is turned on without anyone lying under it, mast 24 will lower until it contacts lower limit switch 30b which then begins the shutdown process of device 11 returning it to the home position and turning off.

Operation of Additional Embodiments FIG. 6A & 6B

Swing arm system 174 is an alternative mounting system for device 11. To position device 11 for therapy using swing arm system 174 release positioning pins 190 and extend upper swimg 184b and lower swing arm 184a while rotating vertical track 192 to align boom 78 parallel to the body and the modality directly over the area to be treated. When the desired position is achieved engage positioning pins 190 into positioning holes 188. If a higher or lower position of mast assemly 22 is desired simply release positioning pin 190 on vertical track 192 and slide vertical rail 194 up or down to a desired level and lock into position by engaging positioning pin 190.

### CONCLUSIONS, RAMIFICATIONS AND SCOPE

Accordingly the reader will see that the automated multiaxis guidance device of this invention can be used to automate numerous therapeutic modalities, has a variety of support bases, is extremely portable and can accommodate the user in a variety of postures on various body support surfaces. In addition the modalities can be interchanged quickly and easily providing the ability to accommodate numerous types of therapy with one device.

Furthermore the automated multiaxis guidance device has the additional advantages in that:

it's compact design allows for easy transportability and storage.

it can be programmed easily by the user as well as the doctor or therapist and because the programming is simple to operate the user can maintain a very relaxed state throughout the course of treatment maximizing the therapeutic benefits.

it provides an extreme level of safety in that programming errors do not result in increased pressure or binding forces placed on the body of the user therefore will not lead to injury and if the user exits the device during operation they will not hurt themselves or damage the device.

modular design of the device allows for easy assembly or disassembly of the various components so the device is more amenable to shipping or repairs if needed.

it can provide a therapy or portion of a treatment without the doctor or therapist being present allowing the doctor or therapist to perform other treatments at the same time which makes the device not only therapeutically valuable but economically valuable as well.

it's unique design with the double four bar mechanism of the arm assembly provides optimal modality contact, comfort and safety by it's ability to follow changes in body size and contours while minimizing any binding forces being applied to the body which allows the user to be clothed for many types of modalities if desired.

Although the description above contains many specificities, these should not be construed as limiting the scope of the invention but as merely providing illustrations of some of the presently preferred embodiments of this invention. For example the device could have a motorized portable base; height extension for the mast; power lift for the arm assembly; powered rotation of the modality; parts made of different materials such as the boom which could be cast in aluminum instead of steel fabrication; a timer and coin operation etc.

Thus, the scope of the invention should be determined by the appended claims and their legal equivalents, rather than by the examples given.

LIST OF REFERENCE NUMERALS

| | |
|---|---|
| Automated multiaxis guidance device | 11 |
| Portable base assembly | 12 |
| Mast foot | 13 |
| Distal foot | 14 |
| Base cross beam | 15 |
| Lockable casters | 16 |
| Retractable stabilizing leg | 18 |
| Mast support post | 20 |
| Mast assembly | 22 |
| Mast | 24 |
| Mast end sprocket | 26 |
| Mast Platform | 27 |
| Mast anchor bolt | 28 |
| Mast - upper limit switch | 30a |
| Mast - lower limit switch | 30b |
| Boom - Proximal limit switch | 30c |
| Boom - Distal limit switch | 30d |
| Arm Limit switch | 30e |
| Mast circuit interface | 31a |
| Boom circuit interface | 31b |
| Mast support bracket | 32 |
| Mast idler sprocket | 34 |
| Mast drive chain | 36 |
| Mast drive motor | 38a |
| Boom drive motor | 38b |
| Roller | 40 |
| Lower mast guide place | 42 |
| Upper mast guide plate | 44 |
| Lid | 45 |
| Mast mounting plate | 46 |
| Housing | 47 |
| Mast counterweight spring | 48 |
| Multi roller | 49 |
| Onboard computer | 50 |
| Programmable controller | 51 |
| Circuit board | |
| D.C. Power Supply | 52 |
| A.C. Relay | 53 |
| Power cord | 54 |
| Casing | 55 |
| Modality power outlet | 56 |
| Pan | 57 |
| Arm wiring port | 58 |
| Computer port | 60 |
| Handheld controller cable | 62 |
| Emergency - shut off | 64a |
| Override - shut off | 64b |
| Arm wiring | 66 |
| U-chain Bracket | 68 |
| Wiring bundle-(boom motor | 70 |
| Encoder, limit switch) | |
| Mast drive sprocket | 72 |
| Boom assembly | 74 |
| Boom Housing | 75 |
| Boom motor cover | 76 |
| Cover plate | 77 |
| Boom | 78 |
| Encoder | 81 |
| Boom drive sprocket | 82 |
| Encoder sprocket | 84 |
| Boom Idler sprocket | 86 |
| Boom chain | 88 |
| End sprocket adjustment screw | 89 |
| Boom end sprocket | 90 |
| Boom anchors(bolts) | 92 |
| Arm carrier | 94 |
| Four bar mechanism A | 96 |
| Optional locking arm hinge | 98 |
| Four bar mechanism B | 100 |
| Arm assembly | 102 |
| Arm mounting bolts | 103 |
| Lower arm bracket | 104 |
| Arm mounting nuts | 105 |
| Upper arm tube | 106 |
| Arm pins | 108 |
| Short brushings | 110 |
| Arm locking pin | 112 |
| Lower arm tube | 114 |
| Adjustable modality | 116 |
| counterweighting spring mechanism | |
| Eye bolts | 118 |
| Adjusting nut | 120 |
| L-bracket anchor | 122 |
| Arm rest | 124 |
| Spring(expansion spring) | 126 |
| Spring link | 128 |
| Upper arm bracket | 130 |
| Links | 132 |
| Bearing dowels | 134 |
| Bearing shoulder bolts | 136 |
| Modality receptacle | 138 |
| Receptacle weight | 139 |
| Receptacle spring | 140 |
| Receptacle spring anchors | 141 |
| Long bearing bushings | 142 |
| Small washer | 143 |
| Receptacle lock | 144 |
| Modality adaptor | 145 |
| Mounting bracket | 146 |
| Rotation stop | 148 |
| Handle brackets | 150a |
| | 150b |
| Rubber bushing | 152 |
| Rubber handle bushing | 154 |
| Handle locks | 156 |
| Boom Wiring port | 158 |
| Bearings | 160 |
| Large washer | 162 |
| Standart bolt | 163 |
| Standard nut | 164 |
| Outboard boom chain anchor | 166 |
| Motor side boom chain anchor | 168 |
| Switch tripping tab | 170 |
| Handheld controller | 172 |
| Swing arm system | 174 |
| Wall | 176 |
| Mounting plate | 178 |
| Large bearings | 180 |
| Mounting screws or bolts | 182 |
| Upper swing arm | 184b |
| Lower swing arm | 184a |
| Position adjustment discs | 186 |
| Position adjustment holes | 188 |
| Positioning Pin | 190 |
| Vertical track | 192 |
| Vertical rail | 194 |
| Controller port | 200 |
| Speed control | 202 |
| Start/stop button | 204 |
| Reverse limit button | 206 |
| Pause button | 208 |
| Forward limit button | 210 |

What is claimed is:

1. An automated multi-axis guidance device, said device comprising an onboard programmable computer means, a power source, interchangeable support means, a mast assembly mounted vertically to said interchangeable support means, a boom assembly mounted horizontally at one end to said mast assembly, said boom assembly including a movable arm carrier, an arm assembly mounted at it proximal end to said movable arm carrier and perpendicular to said boom assembly, with said arm assembly including a receptacle means for attaching a modality adaptor means mounted at the distal end of said arm assembly, whereby taking the place of a doctor or therapist applying a plurity of previously manually operated therapeutic modalities and providing significant versatility.

2. The device set forth in claim 1 wherein one said interchangeable support means is a portable base, said base comprising a horizontal platform of rigid material of predetermined size and shape to accommodate proper positioning of said device to a plurity of support surfaces, a mast support means mounted vertically on the top surface of said base to accommodate attachment of said mast assembly, a plurity of lockable casters mounted to the undersurface of said horizontal platform at spaced locations providing portability and stability of said device, a retractable stabilizing leg mounted to said horizontal platform extending the opposite direction of said arm assembly whereby preventing backward tipping of said device if said arm assembly were abruptly lifted.

3. The device set forth in claim 1, wherein one said interchangeable support means is a wall mounted swing arm system, said system comprising a mast mounting base for attaching said mast assembly, a horizontal position locking means for aligning said device to a plurity of patient positions, a plurity of horizontally aligned swing arms attached together with a plurity of large bearings interconnecting said mast mounting base to a wall mounting plate.

4. The device set forth in claim 3 wherein said mast mounting base includes a vertical adjustment means, said adjustment means comprising a vertical rail sliding within a vertical track, a locking means setting the height of said vertical mast assembly whereby providing accommodation for greater variation in patient size and height of patient support surfaces.

5. The device set forth in claim 1 wherein said mast assembly comprises a means for vertical reciprocal axial movement of a mast, a mast guiding means providing smooth fluent vertical axial movement of said mast, mast counter weighting means comprising expansion springs whereby aiding the lift cycle of axial movement of said mast by off setting the combined weight of attached said boom assembly, said arm assembly and said modality.

6. The device set forth in claim 1 wherein said onboard programmable computer is a programmable controller circuit board, a DC power supply, AC relay, emergency shut off, a mast and arm position sensing means, a handheld controller means wired to said computer for turning said device on or off and setting a multitude of therapeutic parameters.

7. The device set forth in claim 1 and 6 further including a sensing means wired to said onboard programmable computer to determine appropriate position of said mast for optimal function, to set maximum upper and lower limits of vertical reciprocal axial movement of said mast, to set hard and soft limits of horizontal reciprocal axial movement of said arm assembly along said boom comprising a series of limit switches and encoder.

8. The device set forth in claim 6 wherein said handheld controller means comprises a speed control dial, stop/start button, pause button, reverse and forward limit buttons which allow the setting of a multitude of parameters within which a chosen modality will function and can be preprogrammed or reprogrammed at any time by the operator, or by an attending doctor or therapist.

9. An automated multiaxis guidance device as set forth in claim 1 said device comprising a modular design of interconnecting components, said components being an interchangeable support means, a mast assembly, onboard programmable computer a handheld controller for setting treatment parameters or programs, a boom assembly, arm assembly and wiring from said computer to said handheld controller, mast assembly, boom assembly and arm assembly which plugs into specific predetermined wiring ports whereby allowing for quick assembly or disassembly providing easier transport, maintenance and versatility.

10. The device set forth in claim 1 and claim 6 wherein said Boom Assembly comprises a boom, a movable arm carrier, a means for horizontal reciprocal axial movement of said arm carrier along said boom, said limit switches located at the proximal and distal ends of said boom providing hard limits for axial travel of said arm carrier reversing direction of travel of said arm carrier when triggered, said encoder linked to said onboard computer tracking said arm carriers position during operation for setting a multitude of soft limits of travel of said arm carrier through programming of said onboard computer.

11. A device as set forth in claim 1 and claim 10 wherein said boom assembly is a linear tracking means for said modality whereby said modality always tracks longitudinally straight along a persons body or part of a persons body whenever positioned for therapy.

12. The device as set forth in claim 1 wherein said arm assembly comprises a mechanical body contouring means a modality counter weighting means, arm leveling means, optional locking arm hinge allowing said arm assembly to be moved parallel to said boom for more compact storage or transport and locked perpendicular to said boom when in operation, an arm locking pin locking said arm assembly up in its highest position for safer storage or transport, said modality receptacle means providing quick attachment, changing, or rotation of said modality adaptors and respective chosen said modalities.

13. A device as set forth in claim 12 wherein a mechanical body contouring means comprises a unique double four bar mechanism with a proximal four bar mechanism mounted perpendicular to said boom operating in the vertical plane raising and lowering said modality while keeping said modality level for maximum body surface contact and a distal four bar mechanism mounted at it superior end perpendicular to said proximal four bar mechanism with the pivot point of said second four bar mechanism set below the axis of said proximal four bar mechanism operating in a rotating and tipping motion around the axis of said proximal four bar mechanism, a means for preventing over rotation or over tipping of said receptacle means providing smoother transition of said modalities along varying body contours while maintaining maximum surface contact between said modality and a body or part of a body whereby creating a unique body contouring action with out the need for complicated sensor or feedback systems.

14. A device as set forth in claim 12 wherein said modality counter-weighting means is an adjustable spring mechanism for varying lift, proportionate to variable weights of a plurity of said modalities.

15. A device as set forth in claim 12 wherein said arm leveling means is a limit switch wired to said programmable controller means to provide a signal to said mast drive motor to stop lowering said mast when said modality contacts a body or part of a body causing said arm to raise off said limit switch as said arm approximates a horizontal position stopping said mast drive motor whereby providing the most desirable neutral position of said arm assembly for optimal variation of upper or lower vertical travel and maximum modality to body surface contact.

16. A device as set forth in claim 13 wherein said body contouring means allows said modality to automatically and simultaneously move in a rotating, pivoting motion around the transverse axis of said proximal four bar mechanism as well as up and down in the vertical plane following all variations in body contours while said modality and said arm assembly travel longitudinally along said boom.

17. A device as set forth in claim 13 wherein said modality receptacle comprises a means of reducing binding forces between a plurity of said modalities and said body or a portion thereof aiding in body contouring whereby preventing said modalities from binding or jamming on items of clothing or on a body or portion thereof.

18. A device as set forth in claim 17 wherein said means of reducing binding forces comprises said receptacle attached inferiorly to the inferior aspect of said distal four bar mechanism creating a pivoting point of said modalities approximating the contact surface of said modality and said body or portion thereof.

19. A device as set forth in claim 1 wherein said modality adaptor means comprises an attachment means consistent with said receptacle, a weighting means, a conforming means to each predetermined modality, a motion dampening means to reduce the transfer of unwanted stresses or vibration from said modalities to said device a body or portion thereof whereby providing smoother quieter, more pleasant operation of said device.

20. A device as set forth in claim 19 wherein said weighting means may comprise variable weighted materials constructing said modality adaptors, or attachable weights to said modality adaptors.

21. A device as set forth in claim 1 wherein said power supply, comprises an incoming power conversion means, built in overload shut down means, a 12 volt power transformer, whereby said power source can accept either 110W-60 Hz or 220V-50 Hz incoming power supply, converting to 12 volt power output.

22. A device as set forth in claim 1 and 20 wherein said onboard programmable controller means and said drive motors operate on a 12 volt system for increased safety.
